(19) United States
(12) Patent Application Publication
(10) Pub. No.: US 2007/0071538 A1
(43) Pub. Date: Mar. 29, 2007

(54) Cylindrical applicator for dispensing cosmetic compositions

(76) Inventor: Antonio Silvio Sampaio Doria, Sao Paulo (BR)

Correspondence Address: Bliss McGlynn, Suite 600, 2075 West Big Beaver Road, Troy, MI, 48084, US

(21) Appl. No.: 10/572,863

(22) PCT Filed: Apr. 20, 2004
(86) PCT No.: PCT/BR04/00056

§ 371 Date: Mar. 22, 2006

(30) Foreign Application Priority Data
Sep. 23, 2003 (BR) P10305111-0

(51) Int. Cl. B43M 11/02

(52) U.S. Cl. 401/219

(57) ABSTRACT

Cylindrical applicator for dispensing cosmetic compositions in the form of liquid, cream, gel or other, onto the human skin. The invention comprises an applicator in the form of a cylinder (1) of rigid material, encased by pressure inside a seat (2) of resilient material, said seat consists of two semicircular guides (3), joined by two support circles (4), and two inferior braces (5) that define the distribution opening (6), being said cylinder (1) free to roll. The present invention is the main part of the head section of various packages. Said cylinder (1) is coated by the cosmetic product when the container is turned upside-down, and rolled against the skin, applying the product uniformly. When pressed down by internal elements of the cap, the cylinder (1) seal the distribution opening (6). With a larger area of application, the present invention is used to apply a large number of cosmetic products to extensive areas, like the face or the body.

The present invention relates to a cylindrical applicator, also known as “cylinder roll-on”, adaptable to packages of different shapes and kinds, capable of dispensing cosmetic compositions in the form of liquid, cream, gel, or other onto the human skin. The present invention also relates to an innovative method of dispensing cosmetics onto the skin.

### TECHNICAL FIELD AND BACKGROUND ART

Known packages for cosmetic products that are usually spread onto the skin require that the hands be used so that the product is applied to the skin, and thus absorbed. There are also packages with a vaporizer that dispenses the product via a spray. Roll-on packages normally consist of a sphere encased in a round flexible seat, free to roll, and as it rolls the portion that is inside the container is bathed by the cosmetic product, and this product is dispensed onto the target surface.

Although roll-on packages have become popular, they are basically used to dispense one kind of cosmetic, antiperspirants or deodorants. Sun screens and moisturizers are not sold in roll-on packages, due to two factors. The first is the habit of consumers of applying products to the skin with the hands. The second is the shape of the traditional roll-on with a sphere, which does not favor an even, homogenous application of the product. The sphere just touches the skin on a single point, like a circumference and a tangent straight line, and it can roll in any direction, indiscriminately, thus not allowing the user to control the application that will be neither even nor uniform.

Roller-ball packages are ergonomically suitable for product application to the underarm. However, on parts of the human body plainer than the underarm, and on the face, the use of a roll-on package with a sphere is not efficient due to the format of the sphere.

The consequence is that roll-on packages have a restricted use. Consumers generally use the hands to apply cosmetic products, which causes disadvantages. One of them is the fact that the product can be applied in excess, leading to wastefulness. Another disadvantage is that the hands must be washed, which is more laborious and also causes wastefulness. If the user applies cream on his face, he will have as much cream on his face as on his hands, which is inconvenient. As there are many cosmetic products, the disadvantages of their application with the hands vary depending on the product. As for packages with a spray, part of the product evaporates, and part of it does not reach its target.

There is another disadvantage of the application of cosmetic products with the hands. The hands carry infectious microorganisms, and this is why the constant washing of the hands to reduce infection risk was recommended by Semmelweis more than one hundred years ago. Moreover, the hands sweat. Consequently, the product applied to the skin does not have the same quality as the original formula.

Another problem of roll-on packages is its sealing. As the sphere inside the seat is free to roll, and the seat is resilient, there could be a leak when the packages are transported. In most cases, the cap drives the sphere downward against the neck of the container in order to avoid possible leakage.

In view of these problems and the restricted use of roller-ball packages, it is an object of the present invention to provide an applicator with more possibilities of use. Considering the limitations of a sphere, an applicator with a different shape is necessary.

Applicators with different formats have been attemped, apparently without commercial success. In the patent U.S. Pat. No. 4,840,511 (Elongated Roll-on Applicator Package with Resilient Liner), the applicator has the shape of an elongated sphere, therefore the two ends of this applicator are spherical. As the title indicates, the conception of the traditional roll-on with a sphere that turns was slightly modified. The, result is that the format of the applicator and the seat (or neck area, as named) is very complex. The resilient liner, beyond the cap, is another part to be manufactured, increasing production costs.

In the patent U.S. Pat. No. 4,168,128 (Seal Roller Dispensing Package), the shape of the applicator is elliptical, similar to a football. In this case, the process of closing the package, pressing the revolving elliptical element in the opening so that it does not roll, is more complex, and therefore the opening of the container is much smaller than the length of the roller, which can limit the application of the product. The elliptical applicator has two pointed ends, rendering the matching of the seat and the applicator awkward, and difficult to manufacture. With a round shape, the applicator provides only a point of contact with the skin, like roller-ball applicators do, so the application is not uniform.

In view of these problems, an applicator whose shape would render cosmetic product application to the skin even and uniform was devised.

### DISCLOSURE OF INVENTION

The present invention is a cylindrical applicator (1) that, encased in a seat (2), is capable of rolling and dispensing cosmetic compositions of many kinds onto the human skin, with control and homogeneity, and that can be adapted for diverse types of packages. These two elements, together, constitute the main part of the head section of these packages.

The cylinder (1), that can be seen in FIG. 1, has a round wall, such as a tube, and two circular, flat, equal and parallel ends. The cylinder (1) is preferably, but not necessarily, a hollow element, rigid and resistant to deformations. The cylinder must possess an external surface that is not totally smooth in order to adhere and to roll on the user's skin, yet without depressions in which residues can lodge. The edges of the cylinder (1) can be softened so that it is more confortable to the touch.

The seat (2) in which the cylindrical applicator (1) is encased consists of two semicircular-shaped guides (3), directed toward the inside, like two lengthwise sections of one tube. The two guides support the cylinder (1), allowing it to roll. Joining the two guides are two support circles (4), which help support the cylinder and allow it to roll without friction. As can be seen, the support circles are formed by disks of two circumferences. The upper disk is smaller than the lower disk, with a smaller radius. This occurs so that the support circles do not contact the skin, thus allowing the free roll of the cylindrical applicator. Connected to the semicircular guides are two inferior braces (5) that limit the flow of the product. The lower opening between the two guides and the two braces is the distribution opening (6), from which the cosmetic product, stored in a container, flows towards the cylinder (1) that dispenses the product onto the skin. The inferior braces (5) can be of any width, since this does not affect the rotation of the cylinder (1). The seat (2) must be formed of a resilient material, such as foamed polymer, so that the cylinder (1), made of a rigid material, can be encased in it by pressure. FIG. 2 shows the cylinder (1) encased in the seat (2).

One of the objectives of the present invention is to provide a larger surface of application of a cosmetic product to the skin. This application is carried out with control by the user, and is even and uniform. This means that the applied amount of product must remain approximately the same, without waste, and the target surface must receive it evenly, without imperfections. In the case of roller-ball applicators, this does not happen, as was said before. With the cylinder roll-on, the present invention, application is uniform because the cosmetic product is in contact with an entire lenthwise section of the lateral round wall of the cylinder (1), and this wall rolls against the skin. It must be noted that the cylinder (1) revolves around an axis (9) while spheres do not roll around an axis.

Due to the fact that the cylinder wall is straight in the longitudinal sense, application of the product on the skin is homogeneous and constant. While the sphere has only one point of contact with the skin, the cylinder applicator has many points constituting a straight line that contact the skin. When a user applies antitperspirants to the underarm, some movements are required. If the cylinder roll-on were used for this procedure, fewer movements would be necessary. The cylinder roll-on prevents the direct manipulation of the cosmetic product with the hands, guaranteeing hygiene, economy, and pureness of the original product. And since the amount of the product applied is controlled, the cylindrical applicator can also be defined as a doser.

The present invention also presents a method of applying cosmetic products to the skin. For the cylinder to be coated by the cosmetic product, the package must be turned upside-down, so that the product flows towards the distribution opening (6). To apply the product, the user should roll the cylinder (1) against the skin, in a movement perpendicular to the axis of the cylinder. Back to the original upright position, the cylinder will be rolled the same, but now it just spreads the product already applied to the skin. This rolling movement can be compared to a light massage that enables the cosmetic product to penetrate and be absorbed by the skin. After the total absorption of the product, the cylinder will be clean for the next application.

Small variations in the shape of the seat are possible, provided the cylinder (1) can roll freely on the skin. As this invention comprises a revolving element, the cylinder, it can be considered a roll-on package; so, some features of roll-on packages apply here. The cap, for instance, must embody certain features to prevent possible leakage.

A small variation in the seat (2) is presented in FIG. 3. The difference consists of two straight notches (7) in each guide, for the cylinder applicator to fit into the seat easily, in case the seat is made of a material less flexible than it was originally devised.

The seat (2) and the body section of the container can comprise together a single unit, provided the material used is flexible enough for the cylinder to be encased, or can comprise two mouldings which fit together in a fluid tight arrangement; in this case, the seat is made of a flexible material and the container is preferably rigid.

The size of the cylinder (1) and the seat (2) should be adjusted so that the cylinder can rotate and dispense the right amount of the product. Since it is an objective of the present invention to provide an even and uniform application of various cosmetic products, the viscosity of this cosmetic product will determine the ratio of the cylinder diameter to the seat diameter. The regulation of the fit is chosen inversely in conjunction with the viscosity of composition. However, different products are applied in different amounts. Shaving creams, for instance, must be applied in bigger amounts than moisturizers. The cylinder roll-on should provide either a thin-layer application or a thick one.

In principle, the present invention is useful to apply liquid products. In this case, the distribution opening (6) must be reduced to a minimum size.

### BRIEF DESCRIPTION OF DRAWINGS

FIG. 1 is an exploded perspective view of the cylinder (1) and the seat (2), not encased.

FIG. 2 is a perspective view of the cylinder encased in the seat.

FIG. 3 is a perspective view of an alternative embodiment of the seat, here with straight notches.

FIG. 4 is a longitudinal section of a package (10), that shows the seat as part of the body of the package, the cylinder encased in the seat and a cap over the seat.

FIG. 5 is a transverse section taken vertically through the center of the package shown in FIG. 4.

FIG. 6 is a transverse section of said package (10), before the cap seals it.

FIG. 7 is a transverse section of said package (10), with the cap over the seat.

FIG. 8 is an exploded perspective of said package (10).

FIG. 9 is a longitudinal section of another package (20a).

FIG. 10 shows a package (20b) similar to the one shown in FIG. 9, in a smaller size.

FIG. 11 is a transverse section of the package shown in FIG. 9.

FIG. 12 is part of a longitudinal section of the package shown in FIG. 9

FIG. 13 is an exploded perspective of the package shown in FIG. 9.

FIG. 14 is a perspective of another package (30) with the cylinder roll-on, before the cap seals the package.

FIG. 15 is a perspective of a package (40) that consists of a flexible tube with the cylinder roll-on.

FIG. 16 is a perspective of a flexible tube package (50) with the cylinder roll-on, whose cap is provided with screw threads.

FIG. 17 is an alternative embodiment of the cylinder applicator and the seat, in which there is a joint created by a knob and a recess.

FIG. 18 is a section of the seat and the cylinder shown in FIG. 17, fit together.

FIG. 19 is another alternative embodiment of the cylinder and the seat with a pivot joint.

FIG. 20 is a longitudinal section of the embodiment shown in FIG. 19.

FIG. 21 is a section of another embodiment of the cylinder and the seat with a pivot joint.

FIG. 22 is a section of another embodiment of the cylinder and the seat.

FIG. 23 is a section of another embodiment of the cylinder and the seat.

FIG. 24 is a perspective section of the cylinder and the seat, with arrows showing the pressure the cap makes over the cylinder, and the cylinder makes over the seat.

FIG. 25 is a side view of a package that comprises the cylinder, the seat, the body of a container and the cap.

FIG. 26 is a transverse section of another embodiment of the seat, with quadrangular walls.

FIG. 27 is an exploded perspective of the quadrangular seat (2q) and a cylinder.

### MODES FOR CARRYING OUT THE INVENTION

In essence, and at its broadest, the present invention aims to replace the traditional sphere of roll-on packages with a cylinder that renders the application of diverse cosmetic products to the skin even and uniform.

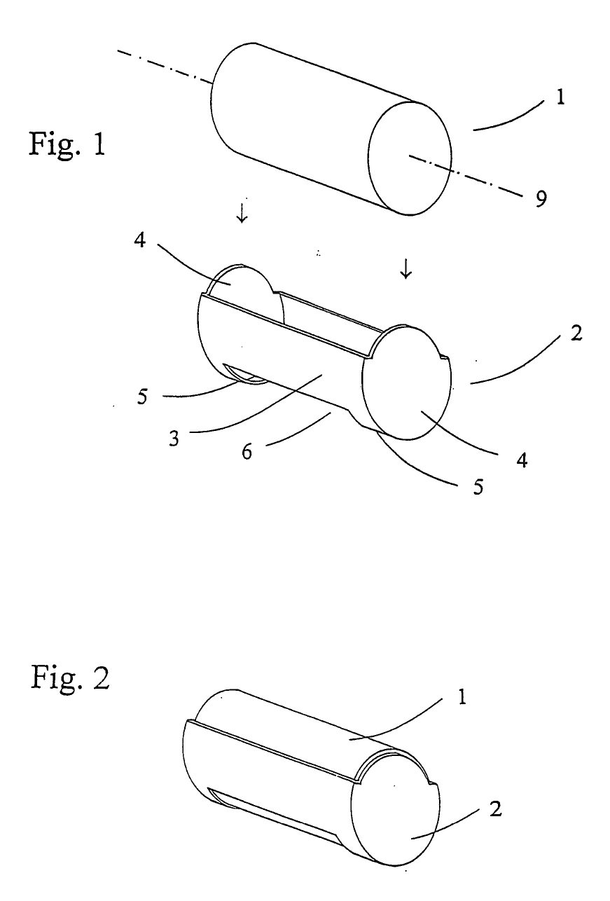

The cylinder (1), that can be seen in FIG. 1, measures from 2.5 to 5 cm in length, or a little more, and its diameter varies from 1 to 2 cm. These measures can be adjusted for various uses, so the cylinder can be slender or thick, depending on its use and on the cosmetic product. The cylinder (1) is preferably, but not necessarily, hollow, made of rigid and resistant material, and has a external surface provided with micro-texture that allows it to adhere to the skin.

The shape of the seat (2) varies depending on the package and its material, provided it allows the cylinder to rotate freely and enables it to seal the distribution opening, when the cylinder (1) is driven down.

It is necessary that the package as a whole enables a conventional user to hold it and manipulate it firmly. This means that the body section of the package must be designed so that it can be grasped by the user, rendering the product application easy and comfortable.

In preferred embodiments, the body of the package is tubular with straight sides, and its shape is in harmony with the perimeter of the cylinder, which means it has a quadrangular shape, preferably with round corners. The body of the package is proportional to the cylinder in terms of width and length, so that the ergonomics of grasping the package and applying the product to the skin is improved.

The head section of the package, which comprises the seat (2) and the cylinder (1), should have round corners, avoiding sharp edges that could brush the skin. The ratio of the head section to the body section of the package is of 1 to 9 in height, not including the cap, but different embodiments can be devised to improve product application.

This invention is applicable to packages in which the container can be rigid or flexible enough to aid flow of the product by squeezing. The cap must have internal elements that drive the cylinder down, thus preventing possible leakage.

Having described the invention in general terms, some preferred package embodiments will be described.

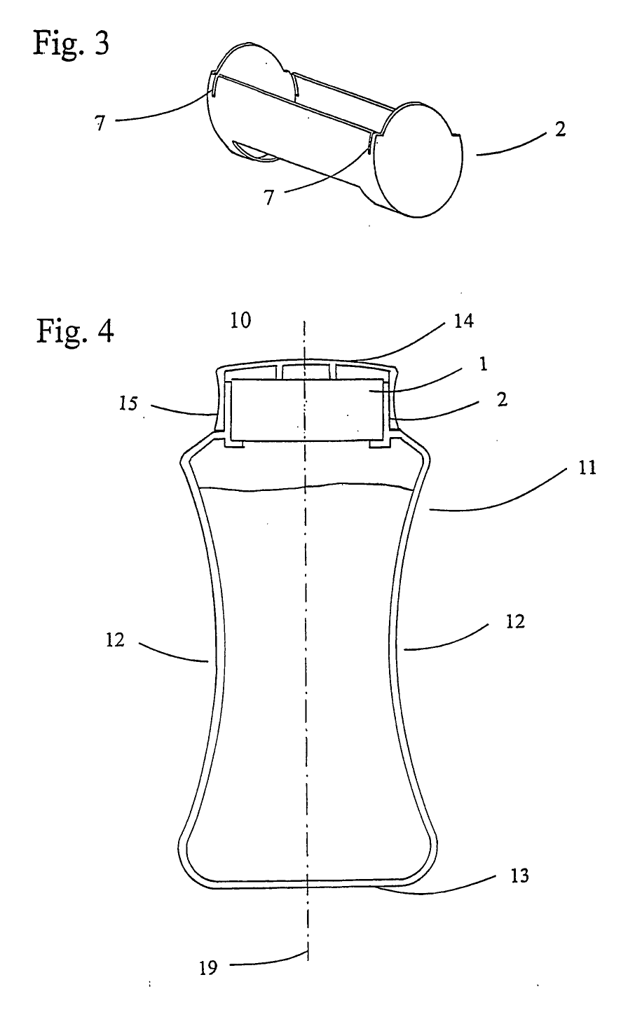

One of the preferred uses of the present invention is shown in FIG. 4, in a longitudinal section of a package (10). It consists of a quadrangular container (11) with longitudinal parallel front and back walls, two side walls (12) curved inward at its center, a base (13) that is a planar surface, which enables the package to stand upright, and seat (2), that forms the mouth of the container.

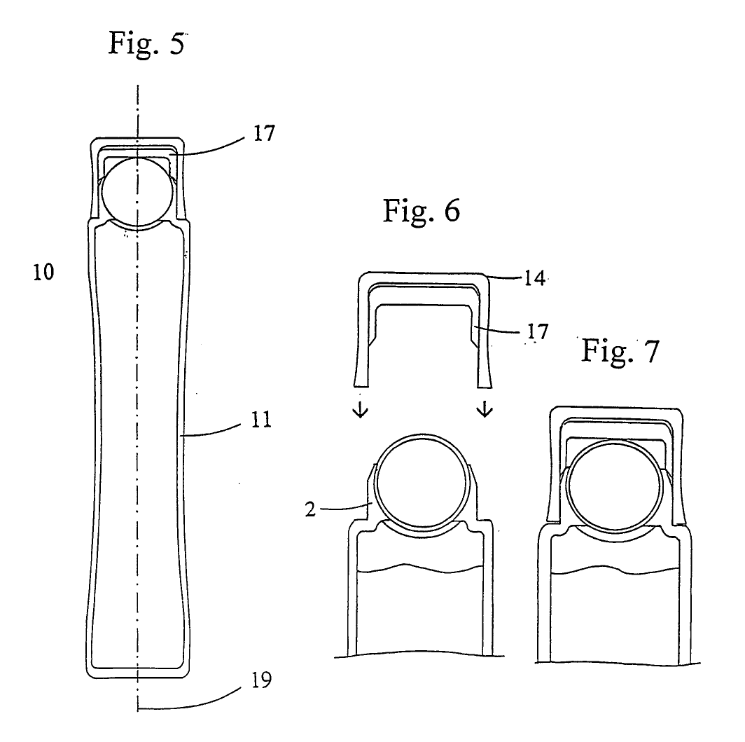

The two side walls (12) curved inward have this shape to enable the user to grasp the package easily and firmly in one hand, and apply the product to the whole body. This package is suitable for applying creams or lotions to the body, such as sunscreens, moisturizers, and the like. The two parallel walls are at the same distance from the main vertical axis (19) of the package, rendering the package stable, as it can be seen in FIG. 5, which shows a transverse section of said package (10).

In this package (10), the container (11) and the seat (2) comprise together one single unit, molded to provide the desired shape, and the material used will be necessarily flexible and resilient. This means the walls of the container are flexible enough to aid flow of the cosmetic product by squeezing.

When the cylinder (1) is encased in the seat (2), the cylinder is partially raised with respect to the seat in such a way that no part of the package hinders the roll of the cylinder on the skin. This means that the upper part of the support circles (4) will be lower than the top of the cylinder (1). The corners and edges of the container are designed so that they do not touch the skin, which would be uncomfortable for the user.

FIG. 4 and FIG. 5 show the package with the mating cap (14) over it. The cap is shaped so that both its longitudinal and side walls (15) are slightly concave. This is more confortable for the user's fingers, and renders the package opening and closing easier.

The cap (14) mates to the seat (2) by being pressed over it. As can be seen in FIGS. 4, 5, 6 and 7, the guides (3) of the seat, seen from the outside, have straight and planar walls. The support circles also become quadrangular on their lower part. The external quadrangular shape of the seat allows the cap to be pressed over it, its walls sliding against the exterior walls of the seat. Since they are tightly fit, and also because the angles involved in this fitting are right angles, the accidental disclosure of the cap is unlikely. The fact that the seat walls are pressed inwardly hinder cylinder rotation.

In order to guarantee a fluid-tight connection, the cap contains two internal structures (17), with the shape of an inverted U. The structures press the edge of the semicircular guides against the cylinder (1), and they also press the cylinder against the distribution opening (6), preventing it from rolling. FIG. 6 and FIG. 7 show the cap being pressed over the seat, and one of the structures (17) pressing the guides edges (3) against the cylinder (1), which in turn is pressed against the opening (6). The distribution opening (6), which is shorter in length than the cylinder, is sealed, and this prevents leakage.

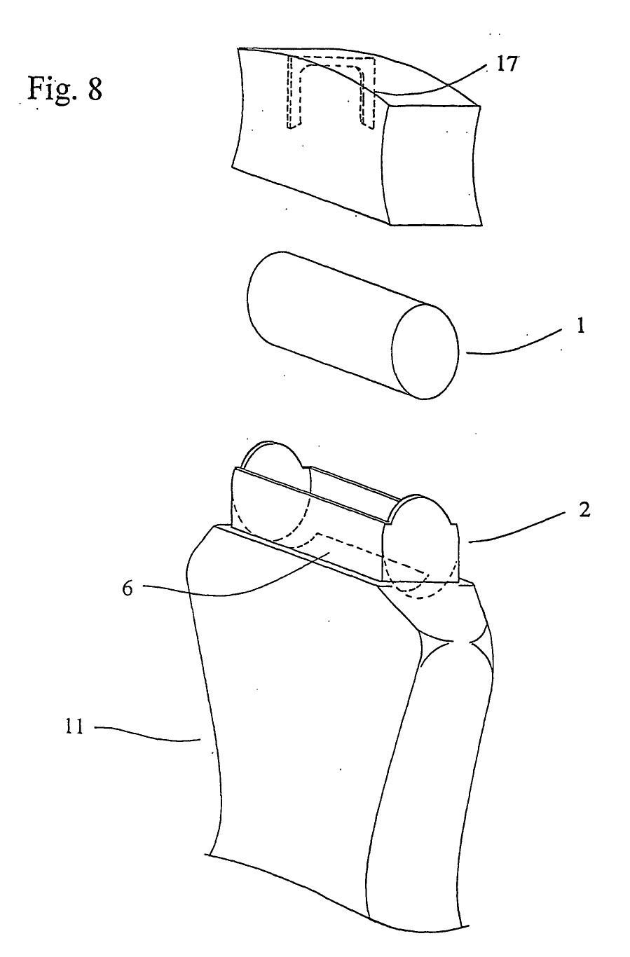

FIG. 8 shows an exploded perspective of the package shown in FIGS. 4, 5, 6 and 7. In FIG. 8, the cylinder (1) is not encased in the seat (2). Dotted lines show the internal part of the seat (2), and the distribution opening (6) defined by the semicircular guides (3) and the inferior braces (5). The drawing of the cap also includes dotted lines that show one of the internal strutures (17).

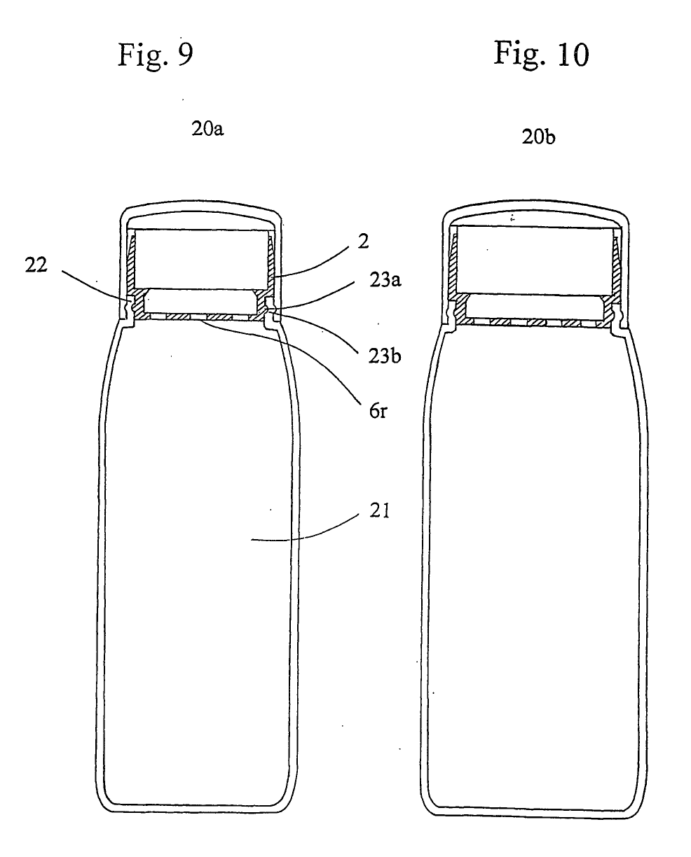

Another preferred package embodiment is shown in FIGS. 9 and 10, which figures consist of longitudinal sections of two packages (20a and 20b, respectivelly). The difference between the two packages is a variation in their length and in the size of the cylinder. FIG. 9 shows a smaller package (20a) devised in order to have a better perfomance when applying cosmetic products to reduced areas, for example to the face. The second package (20b), shown in FIG. 10, bigger than the previous one, is suitable for application to more extensive areas. In both cases, they have a quadrangular shape with parallel longitudinal walls, and two parallel side walls. All four sides taper at the superior part, to shape the mouth (22) of the container (21).

The main difference between these packages (20a; 20b) and the first one (10) is not their shape, but the fact that here (20a; 20b) the seat (2) is distinct from the container; the seat and the container consist of two different moldings that fit together. The seat is made of a flexible material, as to be encased in the mouth (22) of the container (21). The mouth is provided with a groove (23b) for the seat to fit in, and the seat includes a belt (23a) around its inferior part, to fit in the groove and hold the two moldings in place, creating a fluid-tight connection. The container, in this case, is preferably made of a rigid material.

In these packages the seat is provided with another feature. This feature, at the lower part of the seat, is able to controll the flow of the cosmetic product; because of its holes it is called a grating (6r). It helps keep the cosmetic product in the hollow body of the container (21), controlling the release of the product; therefore, the amount of product applied to the skin is reduced to a minimum. Reducing the speed of the flow of the product, this feature makes possible the application of liquid products, or of low viscosity, which is convenient for the user. The number of cosmetic products, lotions, emolients, emulsions that can be used in this procedure is increased. The cylinder roll-on, so, is adaptable to a great variety of cosmetic products.

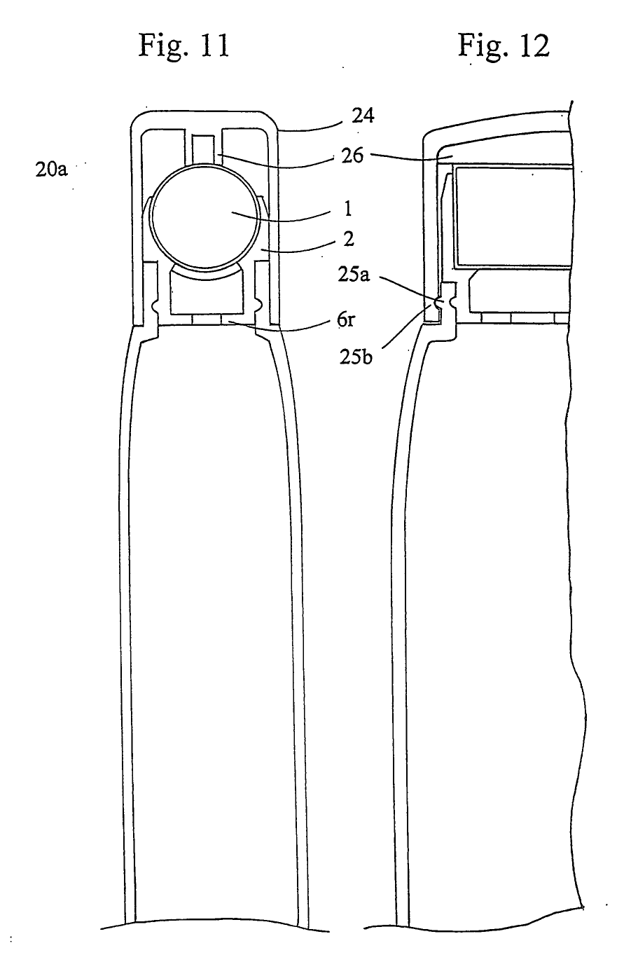

FIG. 11 shows a longitudinal section of said package (20a) and FIG. 12 shows one transverse section of the same package (20a).

The cap (24) of said package (20a), that can be seen in FIG. 11 and FIG. 12, is snapped on and off. The mouth of the container, on it external part, is provided with detent means (25a) that fit in the slots (25b) located inside the cap, on its side walls. When these two parts engage, this can be felt or heard by the user, since the mouth is made of a rigid material and the cap is made of a resilient material, and the joint produces a sound, making sure the package is perfectly closed. The cap is provided with two internal walls (26), that drive the cylinder down, compressing it against the seat (2) and closing the distribution opening. The seat (2) is made of a resilient material that in this case can be synthetic rubber, ore a material with a similar texture, thus allowing the cylinder to fit in it and the seat to mold round the cylinder, for its flexibility.

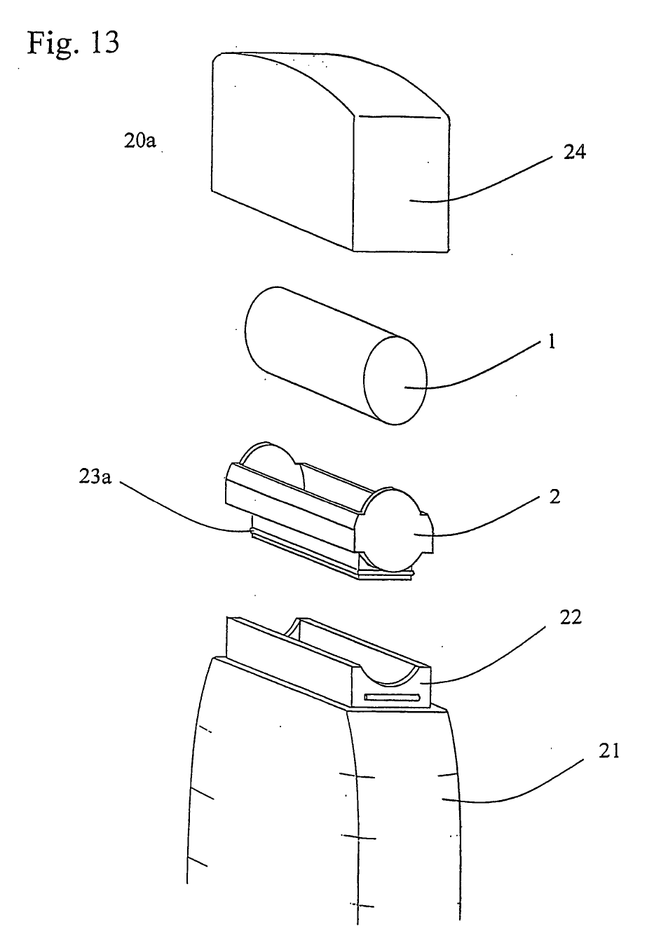

FIG. 13 shows an exploded perspective of the smaller package (20a). Its parts, not assembled, are, from the bottom, the container (21), the seat (2), the cylinder (1), and the cap (24). The seat (2) was shaped to fit within the mouth of the container (22), in a fluid-tight connection, and also to receive the cylinder (1). This is why the seat (2) is rounded, both at the superior and at the inferior part of its side walls, and the mouth (22) is concave on its side walls, for the seat to match it. This allows the mouth to be smaller in size. FIG. 13 also shows the belt (23a) of the seat (2), that creates a fluid-tight connection.

FIG. 14 shows another package with the present invention. In this case, the height of the package (30) was reduced, to enable the application of a antiperspirant product. Its shape is similar to packages with solid deodorant, and it can fit in the hand of a conventional user. The use of this package is similar to the way roll-on packages with antiperspirants are used, which means the package must be turned upside-down for the cylinder to be bathed by the product and then rolled in the underarm. The difference, here, is the length and uniformity of the application, so fewer movements are necessary to carry out this procedure.

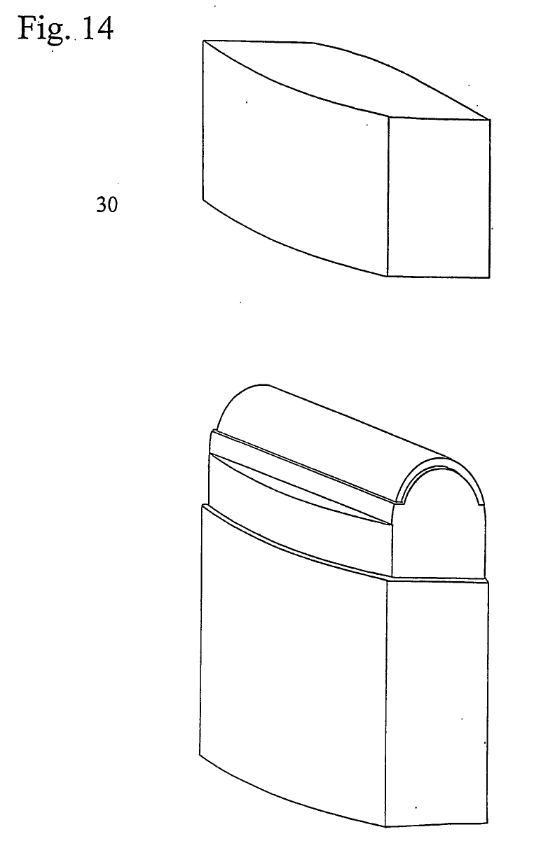

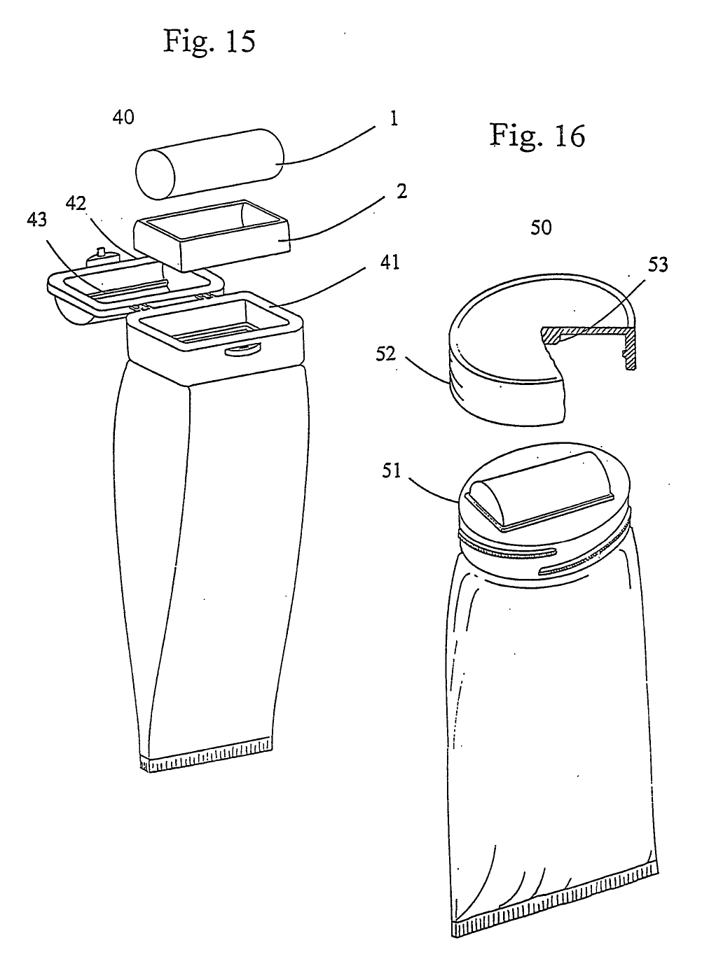

FIG. 15 shows another package with the present invention. In this package (40) the cylinder (1) and the seat (2) were adapted to a collapsible tube, and both are inserted in the quadrangular rigid shoulder (41) placed at one end of the tube; the second end is sealed. The tube is squeezed to have the stored cosmetic product expelled. Here, the product is driven to the shoulder (41) where the seat (2) is encased. With rolling movements of the cylinder on the skin, the cosmetic produtc is expelled and dispensed on it. Because the product is expelled by squeezing the tube, the amount of product is considerably bigger than the amount dispensed by other packages (10, 20a, 20b, 30); this is why this package (40) is suitable for application of shaving produts, in the form of cream or gel.

This package (40) was sized to suit the application of shaving products to the skin. The cylinder here is 3 cm long, or a little more, which is the same length of a shaving blade. The reason for having the same length is the fact that the user, when applying the shaving product, can make the same movements he makes to shave, since these two procedures are subsequent and aim at the same objective. The similarity of movements and the fact that the hands of the user are not demanded to apply the product to the skin render this procedure fast and easy, specially when comparing it to the tradicional method of applying shaving creams to the face. The user generally uses the hands or fingers to apply the product and therefore must wash them before using the razor. He can also make use of a shaving-brush to apply the product to the skin. In this package (40), the cylinder applicator is a substitute for the shaving-brush, which means the package (40), serves both as a container for a cosmetic product and as an instrument that enables its application. Comparing this package (40) to the ones in which the shaving product (foam) is expelled through a spray, the cylinder roll-on allows the user to define the ideal amount of product to be applied, without waste.

FIG. 15 shows the seat (2) encased in the quadrangular shoulder (41) of the package (40). The shoulder (41) is made of a rigid material and the seat (2) is made of a resilient one; the seat is tightly fit in the opening of the shoulder, and the pressure against its walls avoids possible leakage. The cylinder (1), in turn, is encased inside the seat (2) and also prevents possible leakage of the product. The cap (42) is connected to the shoulder (41), and both constitute an only molding; the cap comprises an engaging bolt that slides inside a lateral slot of the shoulder. The cap is provided with longitudinal ridges (43) that drive the cylinder (1) down against the seat (2), sealing the distribution opening and creating a fluid-tight arrangement. The shoulder and the seat can also comprise a single unit, if the material used is flexible enough for the cylinder to be encased in it by pressure.

FIG. 16 shows another package (50) with a flexible tube; here, the shoulder (51) is round (51). The cap (52) is also round and includes internal screw threads; the shoulder (51) is provided with external screw threads to receive the cap (52). The fact that the cap (52) and the shoulder (51) are separated renders the manipulation of this package (50) easier and more comfortable for the user, with more freedom of movements. In the inner part of the cap (52) there is also a raised central knob that depresses the cylinder (1) when the cap (52) is revolved over the shoulder (51), creating a fluid-tight arrangement. The round cap with screw threads can be used in flexibe tube packages, but also in tubular packages, since the screw fit joint is another possibility of creating a fluid-tight connection between the container and the cap, which allows packages to have a greater variety of shapes and uses.

The present invention, which constitutes the main part of the head section of the cited packages (10), (20a), (20b), (30), (40), (50), and that can be adapted to other packages, is therefore defined as an applicator and a doser of cosmetic products that are generally applied to the skin. As the first package embodiment (10) is the simplest and consequently the cheapest one, it can be considered the best mode for carrying out the invention.

### Alternative Embodiments

The present invention was conceived to guarantee a uniform application of cosmetic products to the skin. It was also devised as a very simple tool that embodies all qualities that are required for a package to be manufactured and used on a large scale. The simplicity of the concept renders this possible. However, some alternative embodiments of the cylinder roll-on are possible, provided these principles are observed. The use of elongated or cylindrical rollers is not an original idea, since there are packages that include an elongated roller. However, most of these rollers possess pins on their ends, pins that fulfill the function of an axle, enabling the cylinder to roll.

The existence of rollers with axle pins is common in some packages, for example in the packages for depilatory products. In these packages, rigid and generally resistant, because they must withstand a heating process so that the wax melts, the head section is extremely rigid in order to support the cylinder and enable it to roll when dispensing the melted hot wax, and the cylinder is fixed to its place by axle pins. Since the cylinder is fixed, it can not move to close or seal the existing opening. The present invention differs from these packages since the seat (2) is resilient, and the cylinder (1) is not fixed to its position by axle pins; it is supported by the seat. The cylinder does not have any axle pins and remains free and loose, which makes possible the sealing of the distribution opening when the cylinder is pressed against it.

Alternative embodiments can increase the possibilities of use of the cylinder roll-on, as long as the original concept is preserved.

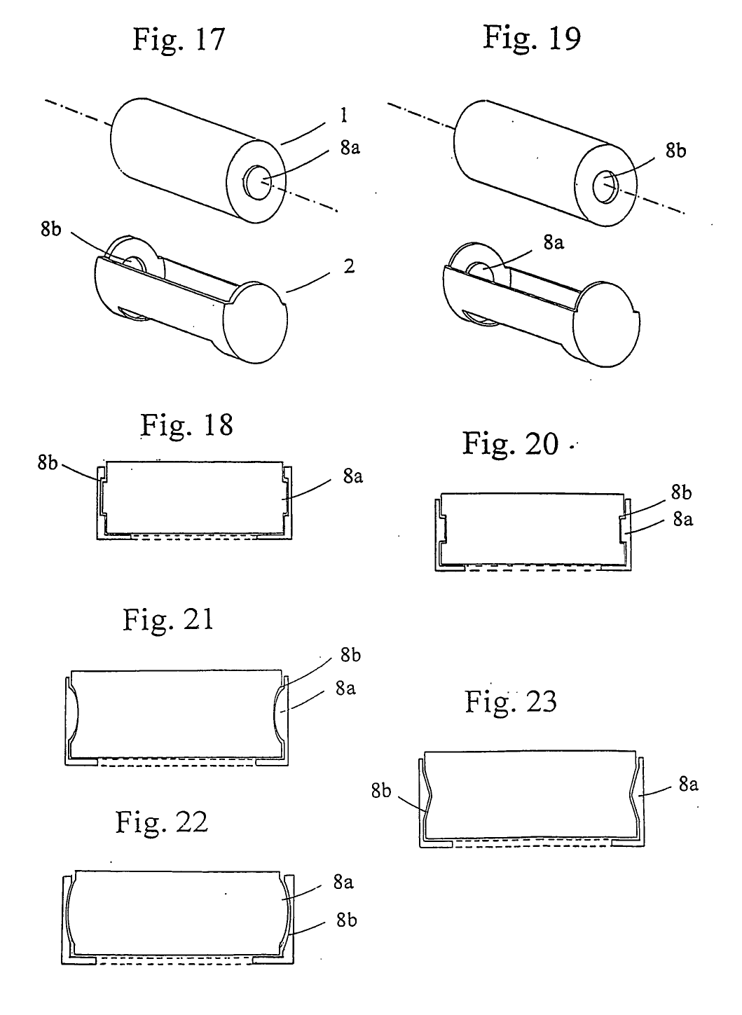

The first alternative embodiment of the cylinder roll-on can be seen in FIG. 17. The new feature is not an axle pin, but a raised element that engages the cylinder (1) and the seat (2). This element protudes from the flat ends of the cylinder (1) like a knob (8a). The engagement knob can be seen in FIG. 18, which shows a longitudinal section of the encased cylinder and the seat. In FIG. 19, the knob (8a) is located inside the seat (2), on the inner part of the support circles (4), and the cylinder (1) is provided with a recess (8b) to receive the knob (8a). The difference between this engaging knob (8a) and the axle pins of depilatory packages is the fact that here there is not a tight-fit connection of the mating elements. There is a loose engagement between the knob (8a) and the round recess (8b), as can seen in FIG. 18 and FIG. 20. The knobs do not support the cylinder, therefore the cylinder (1) is still supported by the seat (2), and the cylinder is still depressed by the cap to seal the distribution opening (6). The function of this loose engagement is to prevent the cylinder (1) from falling off the seat (2) accidentally. If in the first embodiment of the cylinder roll-on the semicircular guides (3) alone are able to keep the cylinder (1) inside the seat (2), in this embodiment there is another element that aims at the same objective, without changing the external shape of the cylinder (1), or the seat (2). But here, the guides can be narrowed, thus allowing for a larger area of the cylinder to be used when applying cosmetic products.

The cylinder roll-on with a loose joint can have different shapes. In FIG. 21, we see a longitudinal section of the seat (2) with convex knobs (8a) on the internal part of the support circles (4), and also the concave recesses (8b) on the cylinder ends. In FIG. 22, we see a similar joint, but with the mating elements in an inverse position.

In FIG. 23 the seat has conical knobs (8a). These construtive variations are useful for the usage of different materials in the manufacturing, materials that could be more or less resilient. In all cases, the cylinder (1) is encased in the seat (2) by being pressed down inside it. Hence the convex knob can be the best shape to create a loose joint. All shapes devised here can be more or less suitable for this purpose depending on the materials and on the machinery used when manufacturing the packages. These variations do not hinder the free roll of the cylinder. As for the sealing of the opening, it remains the same. FIG. 24 shows the pressure made on the cylinder (1) by the cap, and the pressure the cylinder makes on the seat (2). The arrows illustrate how the pressure occurs. As the joint is a loose one, the cylinder can adhere to the seat in the same way, and the sealing is guaranteed. From the outside, the difference between these constructive variations is not perceived. FIG. 25 is a side view of a package with the cylinder applicator that corresponds to any of the variations presented in FIGS. 17, 19, 21, 22 and 23. The area of the cylinder that contacts the skin can be larger, but it is always a straight line on its longitudinal side, and the effectiveness of the application is guaranteed.

In the patent WO 02/28547, entitled Applicators For Health and Beauty Products, the container is round, and there is a telescoping extender with a dispenser head. Although it is quite a distinct concept of package, there is a cylindrical roller for applying a cosmetic product. The cylinder remains in its position due to its axle pins, as can be seen in FIGS. 1, 2, 3, 4 and 5. The pins in this case slide into cradles in the form of short slots in the roller basket. The dispensing roller can move toward and away from the dispensing opening. However, the description of this invention does not indicate clearly how the roller can remain in the desired position, without falling out of the basket. The cap is provided with an interior wall; when placed over the basket, this wall presses the roller down against the toroidal ridge to terminate dispensing. But, as the roller is round, and the basket is a cube, with quadrangular walls, the effectiveness of the sealing is doubtful. On the other hand, as the opening is round and tiny (FIG. 5), the flow of the product is hindered, and the amount of product that reaches the cylinder is not proportional to its length. The application of the product, therefore, may not be constant and uniform. The comparison elucidates in which aspects the cylinder roll-on represents an inovation.

In the patent U.S. Pat. No. 5,158,385, entitled Sealing Cap For Elongated Roll-on Package, the package also includes a cylindrical roller. In this case, the cylindrical roller, as in the patent U.S. Pat. No. 4,840,511, has spherical ends. This shape prevents full contact of the roller with the skin, since the spherical ends are beyond reach when the roller revolves against a flat surface like the skin, and the cosmetic product can accumulate and dry out on this part. The main objective of the invention is to create a ‘sealing cap’ with an aligning disk that is able to seal non-circular openings or containers. As for the position of the cylindrical roller, it is kept in its place by its spherical ends that fit in internal depressions on the walls of the main body of the package, as can be seen in FIG. 1. Not having a seat where the cylinder is encased, and consequently no distribution opening, the flow of the product can not be controlled; indeed, the cosmetic product can reach the depressions of the internal walls, which are concave, and accumulate in this place. With the cylinder roll-on, this does not occur, because the distribution opening (6) prevents excessive flow of the product from the container, and the product is not likely to reach the support circles.

The difference between the patents U.S. Pat. No. 5.158.385 and U.S. Pat. No. 4,840,511 is that in the latter, already quoted in the item ‘Technical Field and Background Art’, the roller is provided with two axle studs that, according to the description of the invention, support the roller when fit into the U-shaped notches, so the roller does not touch the sidewalls of the container; it is just the ‘wiping lip’ that has sligth friccional contact with the roller. This creates the need of other elements to seal the package. In this case, it is a ‘resilient liner’. This liner creates a seal at the upper part of the roller, while in the present invention the seat is at the lower part of the cylinder, when the package is in its upright position. This means that, in the U.S. Pat. No. 4,840,511, the cosmetic product will be able to reach part of the cap, since the liner is part of it, and can accumulate there. As for the patent U.S. Pat. No. 5,158,385, considering the body of the package, the oversized cap and the roller with spherical ends, it is a more complex package and different from the ones shown here; the only thing in common is the elongated roller.

The patents U.S. Pat. No. 5,026,193, GB-2.304.607 and WO-9.811.801 refer to different kinds of packages, but all include a cylindrical roller for application of cosmetic products, and the roller comprises axle pins that keep the cylinder in its position. Considering these packages and also all packages that include a roller with axle pins, there is an inherent difficulty in this concept. The existence of axle pins results in a roller rigidly fixed to a certain position, in a way that the existing opening cannot be sealed. The cylinder itself cannot be used as a means of sealing; therefore, other elements must be devised to provide a fluid-tight arrangement. These elements render the package more complex, and its manufacturing costlier, and in most cases they are not practical. As for the patents U.S. Pat. No. 6,076,984 and ES-2.086.266, these packages are aimed at dispensing hot melt depilatory waxes, and, as is usual in this kind of package, the roller is supported by axle pins.

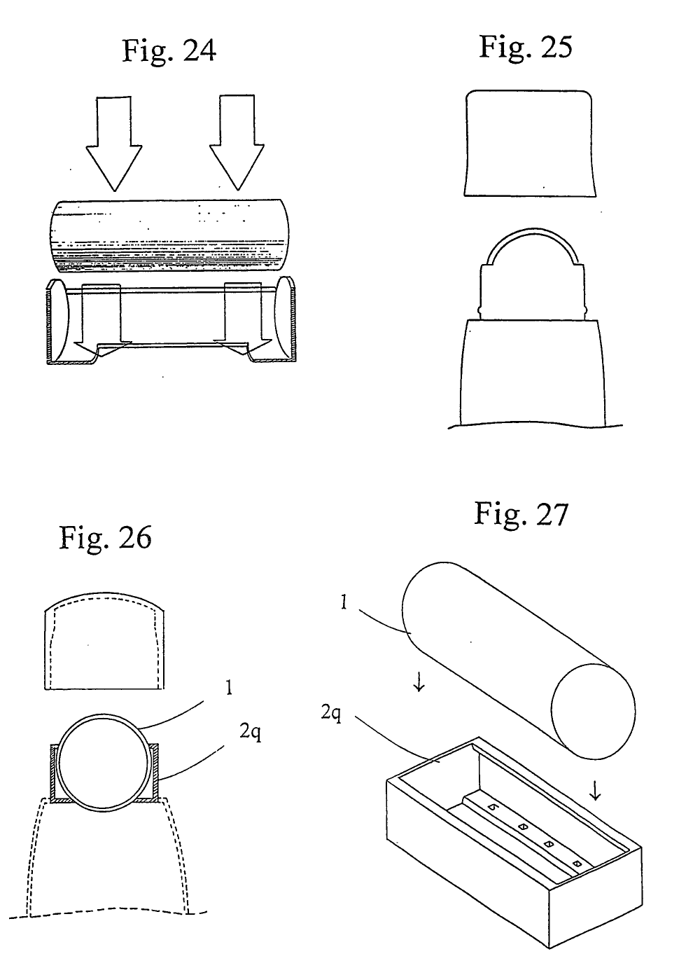

FIG. 26 shows another embodiment of the seat (2q), with a quadrangular shape. As the external walls of the seat must be quadrangular for the cap to snap on and off, this format is convenient. FIG. 27 is an exploded perspective of the cylinder (1) and the quadrangular seat (2q). The seat, a hollow element, has two big openings, one at its inferior part, one at its upper part, and these openings define edges, inside which the cylinder is encased. The edges retain the excess of the product, functioning like wipers, so that the product does not accumulate inside the seat (2q). The lower part is also provided with holes, so that the product drains back to the container. Here, the sealing depends on a sound junction between the superior edges of the seat (2q) and the cylinder, therefore the walls of the cap were thickened at the upper part, in order to push the edges against the cylinder, as can be seen in FIG. 26.

This embodiment of the seat can be combined with other features previously described. The support circles (4), for instance, could be incorporated to the quadrangular seat (2q), so that its ends would be round at the upper part, like the ends of the cylinder (1). All features described before could be combined with the quadrangular seat (2q), and these combinations render the cylinder roll-on a flexibe tool to be used for the application of a great variety of cosmetic products.

1. Cylindrical applicator for dispensing cosmetic compositions in the form of liquid, cream, gel, and others, onto the human skin, adaptable to various kinds and shapes of packages, comprising a cylinder (1), an element bounded by an oblong round wall, such as a tube, and two circular, flat, equal and parallel ends, and a seat (2), which comprises two semicircular guides (3), directed toward the inside, two support circles (4) at its ends formed by disks of two circumferences, being the upper disk smaller than the lower one, with a smaller radius, two inferior braces (5), which define the length of the distribution opening (6), being said cylinder (1) encased in said seat (2) by being pressed into it, where said cylinder (1) is supported mainly by the semicircular guides (3) and is free to roll.

2. CYLINDRICAL APPLICATOR FOR DISPENSING COSMETIC COMPOSITIONS, according to claim 1, which constitutes the head section of packages such as:
(a) tubular packages made of resilient material.
(b) tubular packages made of rigid material.
(c) flexibe tube packages.

3. CYLINDRICAL APPLICATOR FOR DISPENSING COSMETIC COMPOSITIONS, according to claim 1, wherein the seat (2) is part of the main body of the package, being said seat (2) and container molded as a single unit.

4. CYLINDRICAL APPLICATOR FOR DISPENSING COSMETIC COMPOSITIONS, according to claim 1, wherein the seat (2) is a distinct element from the main body of the package, molded separately, made of a resilient material, which seat fits within the mouth of the main body of the package in fluid-tight connection.

5. CYLINDRICAL APPLICATOR FOR DISPENSING COSMETIC COMPOSITIONS, according to claim 1, wherein the seat (2) is provided with two straight notches at the upper part of each semicircular guide (3).

6. CYLINDRICAL APPLICATOR FOR DISPENSING COSMETIC COMPOSITIONS, according to claim 1, characterized in that the seat (2) is provided with a grating (6r), at its lower part, with holes that control the flow of the product.

7. CYLINDRICAL APPLICATOR FOR DISPENSING COSMETIC COMPOSITIONS, according to claim 1, wherein the seat (2) has external quadrangular and planar walls that enable the cap to slide down and fit around it, by pressure.

8. CYLINDRICAL APPLICATOR FOR DISPENSING COSMETIC COMPOSITIONS, according to claim 1, characterized in that the cylinder (1), pressed down by internal elements of the cap, seals the distribution opening (6) of the seat (2) in fluid-tight connection.

9. CYLINDRICAL APPLICATOR FOR DISPENSING COSMETIC COMPOSITIONS, according to claim 1, characterized in that the cylinder (1) is pressed down by a knob inside a round cap, which cap is screw fitted to the container, sealing the distribution opening (6) in fluid-tight connection.

10. CYLINDRICAL APPLICATOR FOR DISPENSING COSMETIC COMPOSITIONS, according to claim 1, wherein the cylinder is provided with knobs at its ends, and the support circles are provided with a recess, which knob and recess together constitute a loose connection.

11. CYLINDRICAL APPLICATOR FOR DISPENSING COSMETIC COMPOSITIONS, according to claim 1, wherein the cylinder is provided with recesses at its ends, and the support circles are provided with knobs, which knobs and recesses together constitute a loose connection.

12. CYLINDRICAL APPLICATOR FOR DISPENSING COSMETIC COMPOSITIONS, adaptable to various kinds and shapes of packages, comprising a cylinder (1), an element bounded by an oblong round wall, such as a tube, and two circular, flat, equal and parallel ends, and a quadrangular seat (2q), comprising four main quadrangular sides, with one opening at the botton and one opening at the top, which openings constitute edges inside which the cylinder (1) is encased, being the botton sides provided with holes.

13. CYLINDRICAL APPLICATOR FOR DISPENSING COSMETIC COMPOSITIONS, according to any preceding claim, characterized in that it constitutes the head section of packages such as:
(a) tubular packages made of resilient material.
(b) tubular packages made of rigid material.
(c) flexibe tube packages.
(d) any other kind of packages.
